(19) United States
(12) Patent Application Publication
(10) Pub. No.: US 2004/0022927 A1
(43) Pub. Date: Feb. 5, 2004

(54) Serial bean products having multi-flavor, multi-variety and rich nutrition

(76) Inventor: Ke-Yi Li, Shanghai (CN)

Correspondence Address: Raymond Y. Chan, Suite 128, 108 N. Ynez Ave., Monterey Park, CA, 91754, US

(21) Appl. No.: 10/629,983

(22) Filed: Jul. 29, 2003

(30) Foreign Application Priority Data
Aug. 5, 2002 (CN) 02266041.0

(51) Int. Cl. A23L 1/36

(52) U.S. Cl. 426/629

(57) ABSTRACT

A serial bean product having multi-flavor, multi-variety, and rich nutrition, includes a predetermined amount of flavor material which is comminuted from a material such as vegetables, fruits, sea foods, domestic birds, wild birds, plants, fungus, or condiments, wherein the flavor material is in form of juice, granules or powder, wherein the flavor material is added into a raw material of bean product to form a composite material. Water may be added into the composite material. The composite material is steamed and mixed to form a semi-product for producing one or more kinds of finished bean product with single or multiple flavors and single or multiple nutrition.

### CROSS REFERENCE OF RELATED APPLICATION

The present invention claims priority of a foreign patent application in the Peoples Republic of China having an application date of Aug. 05, 2002 and an application number of 02266041.0.

### BACKGROUND OF THE PRESENT INVENTION

1. Field of Invention

The present invention relates to a serial of bean products having multi-flavor, multi-variety, and rich nutrition, and more particularly to the bean products that are able to renovate and replace the conventional ones.

2. Description of Related Arts

Regarding to the conventional bean products, varieties are rarely renovated, flavors remains unchanged, and nutrition is far from complete and perfect. In view of the current bean products such as bean curd, semi-congealed bean curd, dried bean curd, and treated dehydrated bean curd, it is found that although there are quite a lot of varieties, the flavors have not changed much since the ancient days they were invented. It is becoming harder and harder for them to meet the growing requirement of people for delicious foods.

### SUMMARY OF THE PRESENT INVENTION

The main object of the invention is to renovate the single variety of traditional bean products. A flavor material such as vegetables, fruits, sea foods, domestic birds, wild birds, plants, fungus, or condiments is comminuted and a flavor material produced therefrom, such as juice, granules, or powder, is then added into a raw material of a bean product and evenly mixed. A single-flavor and single-nutrition product made up of one raw material of a bean product and one flavor material is then produced. If more than one flavor materials are added into the raw material of a bean product, a multi-flavor and multi-nutrition product is also able to be produced.

Another object of the invention is to provide a bean product having a new flavor and a new nutritious combination. More than one flavor materials produced from respective raw material are able to be added into the raw material of a bean product and then evenly mixed. A bean product having composite flavor and nutrition is then able to be made.

In order to accomplish the above objects, the present invention, a serial bean product having multi-flavor, multi-variety, and rich nutrition, is produced as following: adding a certain amount of juice, granules, fine granules, or powder of one or more flavor materials such as vegetables, fruits, sea foods, domestic birds, wild birds, plants, fungus, and condiments into a raw material of bean product; adding a certain amount of water and then steaming to produce a series of semi- or finished bean products.

Accordingly, b y adding the flavors and nutrition of the flavor, the tastes and nutrition of the novel products are much improved and increased, keeping original taste thereof. More than one different flavor materials or the juice, granules, fine granules, or powder thereof are able to be mixed together to create a new combination. The product is able to be a composite material. The flavor thereof is able to be composite flavor. The nutrition is able to be composite nutrition. For a single new product, the flavor is able to be single-flavor and single-nutrition, or multi-flavor and multi-nutrition, or even composite flavor and composite nutrition. For the serial bean products, the flavor is able to be single-flavor and single-nutrition, or multi-flavor and multi-nutrition, or even composite flavor and composite nutrition.

Thereby, the improvement features are concluded that flavor and nutrition of the finished bean product is increased and improved, keeping original taste of the bean and acquiring the flavor and nutrition from the flavor material. More than one different flavor materials are able to be mixed together to create a new combination. The product is able to be a composite material. The flavor thereof is able to be composite flavor. The nutrition is able to be composite nutrition. For a single new product, the flavor is able to be single-flavor and single-nutrition, or multi-flavor and multi-nutrition, or even composite flavor and composite nutrition. For the serial bean products, the flavor is able to be single-flavor and single-nutrition, or multi-flavor and multi-nutrition, or even composite flavor and composite nutrition.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of one embodiment of the invention showing a process of the invention.

FIG. 2 is a schematic view of another embodiment of the invention showing another process of the invention.

### DETAILED DESCRIPTION OF THE PREFERRED EMBODIMENT

The invention, a serial bean product having multi-flavor, multi-variety, and rich nutrition, is produced as following: adding a certain amount of juice, granules, fine granules, or powder of one or more flavor materials such as vegetables, fruits, sea foods, domestic birds, wild birds, plants, fungus, and condiments into a raw material of bean product; adding a certain amount of water and then steaming to produce a series of semi- or finished bean products.

Accordingly, by adding the flavors and nutrition of the flavor, the tastes and nutrition of the novel products are much improved and increased, keeping original taste thereof. More than one different flavor materials or the juice, granules, fine granules, or powder thereof are able to be mixed together to create a new combination. The product is able to be a composite material. The flavor thereof is able to be composite flavor. The nutrition is able to be composite nutrition. For a single new product, the flavor is able to be single-flavor and single-nutrition, or multi-flavor and multi-nutrition, or even composite flavor and composite nutrition. For the serial bean products, the flavor is able to be single-flavor and single-nutrition, or multi-flavor and multi-nutrition, or even composite flavor and composite nutrition.

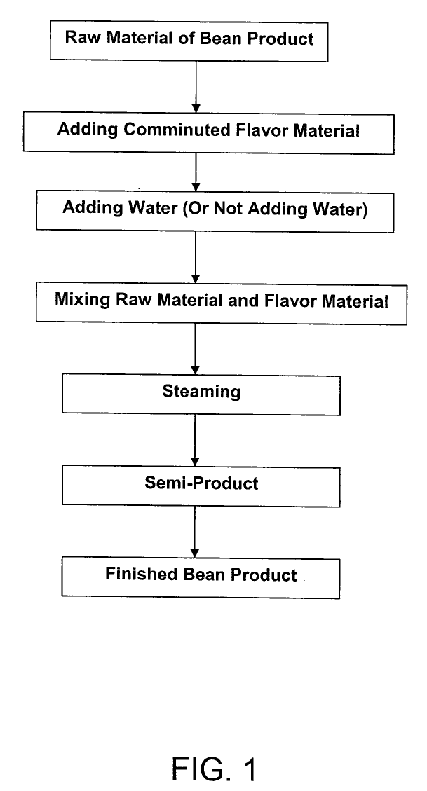

FIG. 1 illustrates a process of producing a new kind of bean food, which comprises the steps of:

(a) adding water into the raw material of the bean product;

(b) adding a certain amount of juice, granules, fine granules, or powder of one flavor material such as vegetables, fruits, sea foods, domestic birds, wild birds, plants, fungus, or condiments into the raw material;

(c) mixing; and,

(d) steaming the bean product to form a semi- or finished bean product.

Before the step (d), the process may include an additional step of adding water therein.

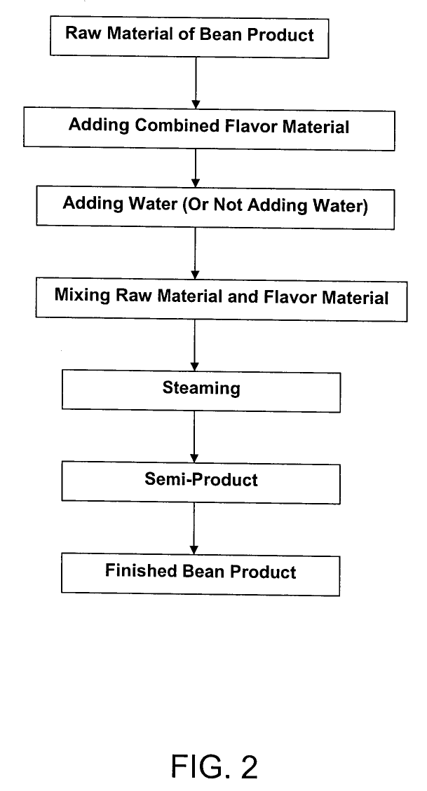

As shown in FIG. 2, another process of producing a new kind of bean food is illustrated. The flavor material added in the step (b) is a mixed combination of more than one materials selected from vegetables, fruits, sea foods, domestic birds, wild birds, plants, fungus, and/or condiments.

The produced semi- or finished product is a novel food. It not only effectively improves the color, smell, and taste of such kind of bean products, but also adjusts the nutritious combination thereof, and also increases the quality and level thereof. It sets up a new generation of serial foods being convenient, useful, and various.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A serial bean product having multi-flavor, multi-variety, and rich nutrition, being produced by adding a certain amount of juice, granules, fine granules, or powder of one or more flavor materials such as vegetables, fruits, sea foods, domestic birds, wild birds, plants, fungus, or condiments into a raw material of bean product and adding a certain amount of water and then steaming to produce a series of semi- or finished bean products, whereby through adding the flavors and nutrition of the flavor, the tastes and nutrition of the novel products are much improved and increased, keeping original taste thereof; more than one different flavor materials or the juice, granules, fine granules, or powder thereof are able to be mixed together to create a new combination; the product is able to be a composite material; the flavor thereof is able to be composite flavor; the nutrition is able to be composite nutrition; for a single new product, the flavor is able to be single-flavor and single-nutrition, or multi-flavor and multi-nutrition, or even composite flavor and composite nutrition; for the serial bean products, the flavor is able to be single-flavor and single-nutrition, or multi-flavor and multi-nutrition, or even composite flavor and composite nutrition.

2. The bean product, as claimed in claim 1, wherein more than one different flavor materials or the juice, granules, fine granules, or powder thereof are able to be mixed together to create a new combination; the product is able to be a composite material; the flavor thereof is able to be composite flavor; the nutrition is able to be composite nutrition; for a single new product, the flavor is multi-flavor and multi-nutrition, or even composite flavor and composite nutrition; for the serial bean products, the flavor multi-flavor and multi-nutrition, or composite flavor and composite nutrition.

3. The bean product, as claimed in claim 1, wherein one flavor materials or the juice, granules, fine granules, or powder thereof is added into said a raw material of bean product; for a single new product, the flavor is single-flavor; for the serial bean products, the flavor is single-flavor.

4. The bean product, as claimed in claim 2, wherein more than one different flavor materials or the juice, granules, fine granules, or powder thereof are able to be mixed together to create a new combination; the product is able to be a composite material; the flavor thereof is able to be composite flavor; the nutrition is able to be composite nutrition; for a single new product, the flavor is multi-flavor and multi-nutrition, or even composite flavor and composite nutrition; for the serial bean products, the flavor multi-flavor and multi-nutrition, or composite flavor and composite nutrition.

5. A process of producing a kind of bean food, comprising the steps of:
(a) adding water into the raw material of the bean product;
(b) adding a certain amount of juice, granules, fine granules, or powder of one flavor material such as vegetables, fruits, sea foods, domestic birds, wild birds, plants, fungus, or condiments into the raw material;
(c) mixing; and,
(d) steaming the bean product to form a semi- or finished bean product; and,
before the step (d), the process may include an additional step of adding water therein.
